(19) United States
(12) Patent Application Publication
(10) Pub. No.: US 2007/0028024 A1
(43) Pub. Date: Feb. 1, 2007

(54) Method for operating a plurality of subscribers connected to a serial bus

(76) Inventor: Gerhard Kottschlag, Hildesheim (DE)

Correspondence Address: KENYON & KENYON LLP, ONE BROADWAY, NEW YORK, NY, 10004, US

(21) Appl. No.: 11/493,871

(22) Filed: Jul. 24, 2006

(30) Foreign Application Priority Data
Jul. 25, 2005 (DE) 10 2005 034 598.0

(51) Int. Cl. G06F 13/14

(52) U.S. Cl. 710/305

(57) ABSTRACT

A method for operating a plurality of subscribers (X1, . . . , X4; Y1, . . . , Y4; Z1, . . . , Z4, B, C1, C2, D, E) that are connected to a serial bus, the bus including at least one address line for addressing the subscribers (X1, . . . , X4; Y1, . . . , Y4; Z1, . . . , Z4, B, C1, C2, D, E). In order to create as simple as possible and as cost-effective as possible a possibility of being also able to operate such subscribers as are originally addressed via the same address, it is provided that at least those subscribers (X1, . . . , X4; Y1, . . . , Y4; Z1, . . . , Z4, C1, C2) who originally are addressed via the same address be connected in series to the address line (3), and the address for the postconnected subscriber(s) (X2, . . . , X4; Y2, . . . , Y4; Z2, . . . , Z4; C2) be transmitted via the preconnected subscriber(s) (X1; Y1, Z1; C1).

### RELATED APPLICATION INFORMATION

This application claims priority to and the benefit of German Patent Application No. 102005034598.0, which was filed in Germany on Jul. 25, 2005.

### FIELD OF THE INVENTION

The present invention relates to a method for operating a plurality of subscribers connected to a serial bus. The bus includes at least one address line for addressing the subscribers.

In addition, the present invention relates to a plurality of subscribers connected to a serial bus. At least some of the subscribers are addressable via the same address. The bus includes at least one address line for addressing the subscribers.

### BACKGROUND INFORMATION

Various digital data buses are discussed in the related art, which connect a plurality of communications subscribers to one another for an organized communications exchange. Often, a point-to-point communication is set up between two subscribers by having one subscriber, as master, controlling the course of the communication by a suitable communications protocol, and an additional subscriber, as slave, adjusting to this specified protocol. If there are no special selection signals (for instance, chip-select lines) are present in the bus system, the master selects a communications subscriber by calling the bus address of the desired communications subscriber or the corresponding module. The address is transmitted via the bus, or, more exactly, via the address line, whereby only the addressed subscriber is authorized for the communication.

In some implementations, such as the I²C bus, the subscriber addresses are preprogrammed in the electronic modules already during the manufacture of the modules. In some modules, one is able to switch over to some few alternative addresses, by an external wiring configuration. In the case of digital modules, this often takes place by digital signals to connecting pins of the module. With increasing miniaturization of the modules, the positioning of many connecting pins on the module becomes increasingly difficult, so that the number of alternative addresses is very limited. Many modules are therefore able to be switched over only between two addresses, or even offer no selection possibility at all, but only one fixed address that is programmed in.

This limitation to one or a few addresses in the known modules becomes a problem especially if two or more similar modules are connected to and operated on the same bus, and all these modules react to the same address. If one of these modules were called by the master, by calling the appropriate address, a plurality of modules would immediately feel that they had been addressed, and the result would be data chaos. Therefore, the manufacturer of the modules (IC manufacturer), by making available of address alternatives, has to establish, already during chip design, how many similar modules are later to be operated in a bus system on the same bus. Thus, it is conceivable, for instance, in the field of consumer electronics, to connect two similar audio modules for one stereo output of audio signals, four similar audio modules for a quad output of audio signals and six similar audio modules for one surround output of audio signals to one I²C bus. These similar audio modules have to be designed in such a way that at least two, four or six different bus addresses are made available, depending upon the application.

If more similar bus subscribers having the same bus address are connected to one bus than the bus subscribers are able to make available different addresses, according to the present related art, a separate multiplexer module is used for partitioning the bus into several subbranches. The modules having the same bus address are distributed to the various subbranches. By the implementation of specific switchover instructions to the multiplexer it is ensured that in each case only one module is addressed. Furthermore, one may construct one or more additional independent buses to which the modules are then distributed that are addressable via the same bus address. Both these proposals, the partitioning of the bus into several subbranches and setting up additional independent buses are connected with considerable additional costs, which, especially in consumer electronics, and in the automotive field is a problem, since in these fields, the success of a product or of a system is decided especially on price.

### SUMMARY OF THE INVENTION

An object of the present invention concerns creating the possibility of operating a plurality of subscribers connected to a common serial bus, which are addressable via the same address, without great expenditure and while avoiding greater costs in the bus system.

In order to attain this object, starting from the method of the type discussed above, it is provided that at least those subscribers which are originally addressed via the same address, are connected in series to the address line, and the address for the subsequent subscriber(s) is transmitted via the preconnected subscriber(s).

Thus, according to the exemplary embodiment and/or exemplary method of the present invention, a modified bus structure is provided, together with one of several possibilities for implementing the bus interface of the connected modules. The exemplary embodiment and/or exemplary method of the present invention makes possible, particularly in the case of serial buses, the collision-free operation of several subscribers that use the same addresses, at least still during initialization of the bus system. For this, the signal line of the bus, which transmits the addresses, is partitioned into several subbranches, which in each case connect two of the modules having the same address to each other, so that overall a stringing together of all the modules having the same address takes place. Only one of the subscribers is directly connected to the address line. All remaining subscribers having the same address are connected to the address line only indirectly, via the subscribers preconnected to them. The subscribers themselves are able to function as nodes between the subbranches.

The concept used, according to the exemplary embodiment and/or exemplary method of the present invention, of the address line is not limited to one line that is exclusively used for addressing. The concept of address line relates to lines via which, on the one hand, signals for addressing the subscribers and, on the other hand, also other signals are able to be transmitted. Thus it also includes lines having mixed functions.

In the bus system, addresses and data are frequently transmitted over the same lines, for instance, in time-multiplex operation. This is also the case in one specific embodiment of the bus structure, the I²C bus. Other signals, such as a clock signal, may furthermore be routed directly to all subscribers.

Thus, according to the exemplary embodiment and/or exemplary method of the present invention, the subscribers which are originally addressable via the same addresses, are no longer all connected to the main bus in parallel, but they are cascaded, in a manner of speaking. Only a first subscriber is directly connected to the original bus. It forms a transition node to the subsequent bus segment by passing on a part of, or all the instructions which it receives via the bus to an additional connection, via which it is connected to an additional subscriber that has the same construction. In this context, depending on the embodiment of the present invention, these instructions in the first module may be subordinated to specific changes, such as an address conversion. The subsequent, second subscriber passes on the instructions received, possibly modified or selected again, to a third subscriber, and so on.

With the exemplary embodiment and/or exemplary method of the present invention it is possible to operate a plurality of similar modules, which are originally addressed via the same addresses, on a common serial bus. Suitable hardware modules for implementing the exemplary embodiment and/or exemplary method of the present invention are conceivable, for instance, for retrofitting slots of the modules. Before the initial operation of the buses, the addresses of the various subscribers do not have to be fixed (for instance, by wire straps or so-called jumpers). Rather, it is possible flexibly to specify the addresses of the various subscribers during the initialization phase or during the normal operation of the bus for the purpose of information transmission. On the subscriber modules, only one additional pin is required for passing on the received addresses and instructions to the post-connected subscriber.

Described herein are other advantageous embodiments of the present invention. According to one exemplary embodiment, during the actual operation of the bus for the purpose of information transmission, an address conversion is carried out of the originally same address to different addresses of the subscribers that are connected one after the other. The address conversion may take place either in a master-subscriber or in the subscribers, that are connected one after the other, themselves. In other exemplary embodiments, the address conversion is carried out in all except the last of the subscribers that are connected one after the other. Of course, the rules for address conversion are also filed in the last subscriber, and an address conversion according to the rules according to the exemplary embodiment and/or exemplary method of the present invention is also able to take place in the last subscriber. However, no subsequent subscriber, that will react to these rules or instructions, is connected to the last subscriber. This being the case, in practice one may do without executing the address conversion in the last of the subscribers that are connected one after the other. In the specific embodiment in the case in which an incoming address for a subscriber connected one after the other is not the address of the subscriber, the master has the information as to the post-connected subscriber to whom the address is assigned.

One advantage of the bit-synchronous transmission of the addresses and the instructions from one subscriber connected one after the other to the subsequent subscriber is, according to another exemplary embodiment, that no additional memory is required for intermediate storage of addresses or instructions and that, because of the address conversion, except for the gate propagation delay, no delay takes place in the information transmission via the bus. The exemplary method according to the present invention, having the features of an exemplary method, has the advantage that not only the bit that is currently received in a preconnected subscriber and is at hand for being passed on to the postconnected subscriber, but specifically any address bit of an incoming and intermediately stored address is able to be manipulated before the address is passed on to the postconnected subscriber. In this way, the number of similar subscribers, which are originally addressable via the same addresses, is not limited by the bit length, that is, the number of bits of the address, but only by the number of all free addresses (2ⁿ for a bit length n) or the efficiency of the address conversion.

Another exemplary embodiment has the advantage that, after running through the initialization phase, during the course of which a reprogramming of the original same addresses of the subscribers connected one after the other to different addresses takes place, the subsequent information transmission is able to take place quite normally, without additional address conversion, during the actual operation of the bus. Alternative addresses which are assigned to the bus subscribers that are connected one after the other during the initialization phase, are able to be specified either by a master subscriber or to be already provided in the various subscribers.

### BRIEF DESCRIPTION OF THE DRAWINGS

FIG. 1 shows a first bus structure for implementing the exemplary method according to the present invention.

FIG. 2 shows a second bus structure for implementing the exemplary method according to the present invention.

FIG. 3 shows a third bus structure for implementing the exemplary method according to the present invention.

FIG. 4 shows an exemplary method sequence according to the present invention in light of the bus structure of FIG. 2.

FIG. 5 shows a usual bus structure from the related art.

### DETAILED DESCRIPTION

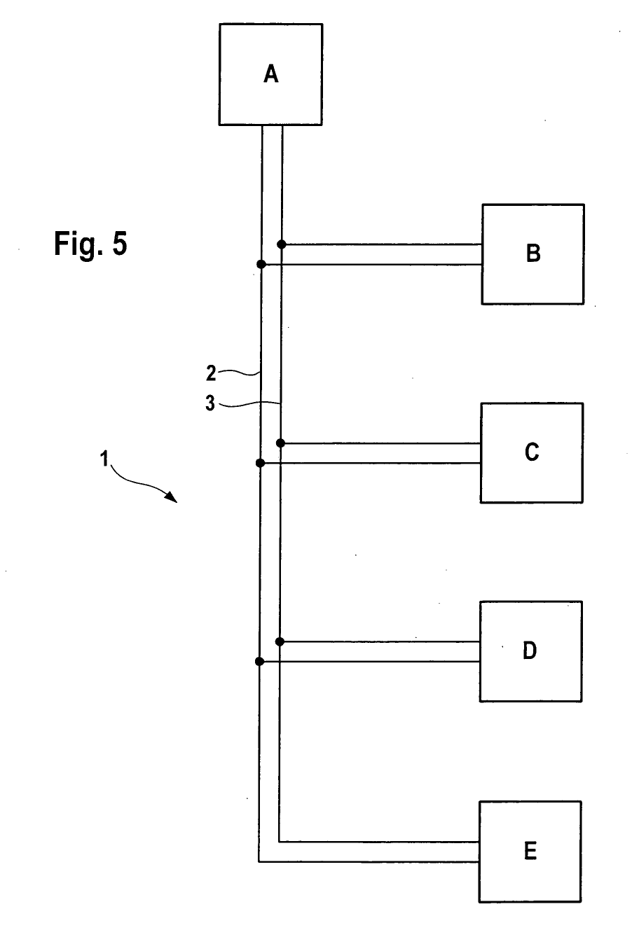

A bus structure from the related art is shown in FIG. 5. It has a data bus 1 which includes a first line 2 for transmitting a clock signal and a second line 3 for transmitting a data signal. In addition, the bus structure includes a master subscriber A as well as several slave subscribers B, C, D, E, which are all connected directly to the data bus, and are connected to one another via it for the purpose of data and information exchange. The bus structure shown in FIG. 5 is equivalent, for example, to the structure of a known I²C bus. Address signals are also transmitted via line 3 for the transmission of data signals, for instance, in time-multiplex operation. Accordingly, first the addresses are transmitted via line 3 and subsequently the data determined for the already transmitted addresses.

In the known bus structures, problems arise if several similar subscribers B, C, D, E, which are all addressable via the same addresses, are connected to bus 1, and are to be operated in the bus system. In such a case, in the known bus structure, in response to a call of an address assigned to several subscribers B, C, D, E by master subscriber A, right away several subscribers B, C, D, E will feel that they have been addressed, and as a result, a data transmission chaos could occur on bus 1, especially in response to read accesses of the master.

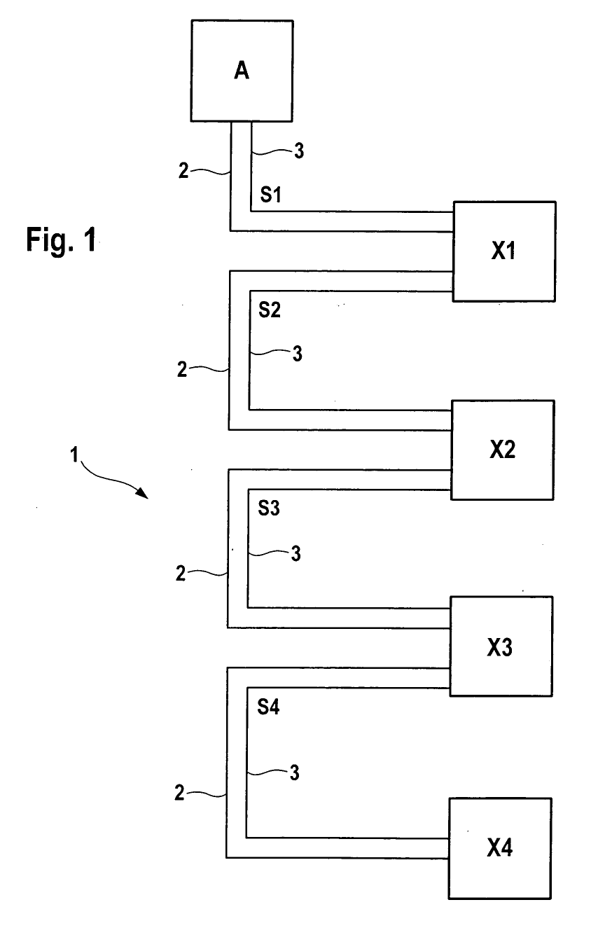

The exemplary embodiment and/or exemplary method of the present invention provides a remedy for this. A completely new bus structure is provided, in which line 3 for transmitting the address signals is looped through those subscribers X1, X2, X3, X4 which, at least at the point in time of initializing the bus system, are addressable via the same bus addresses, so that bus 1 and line 3 are subdivided into several segments for transmitting the address signals. In the exemplary embodiment of FIG. 1, bus 1 is subdivided into four segments, which are designated as S1, S2, S3 and S4. In the bus structure according to the exemplary embodiment and/or exemplary method of the present invention, it is thus not possible for master subscriber A to address one of slave subscribers X2-X4 directly. Addressing slave subscribers X2-X4 is only possible indirectly via first slave subscriber X1. In the exemplary embodiment shown in FIG. 1, in addition to line 3, line 2 is also looped through all the slave subscribers X1-X4.

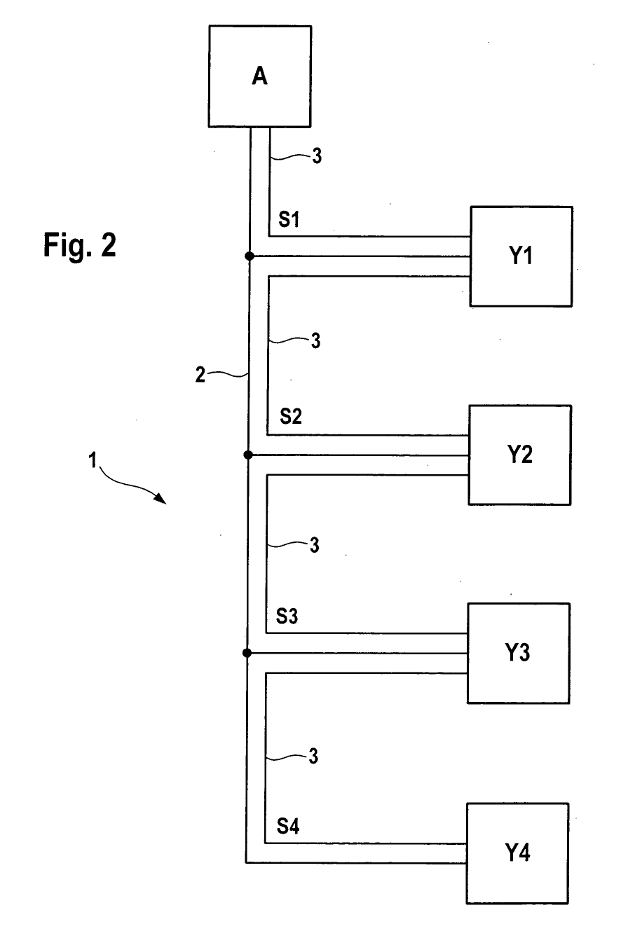

By contrast, line 2 for the clock signal is separately routed to each of the slave subscribers Y1, Y2, Y3, Y4 in the exemplary embodiment shown in FIG. 2, as is also customary per se in the related art, cf. FIG. 5. Line 3, however, for transmitting the address signals, is also looped through all slave subscribers Y1-Y4 in the exemplary embodiment of FIG. 2, and is thereby subdivided into altogether four segments S1-S4. In the exemplary embodiment of FIGS. 1 and 2, the bus structure shown includes, besides master subscriber A, exclusively such slave subscribers X1-X4 or Y1-Y4 which are originally addressable via the same addresses.

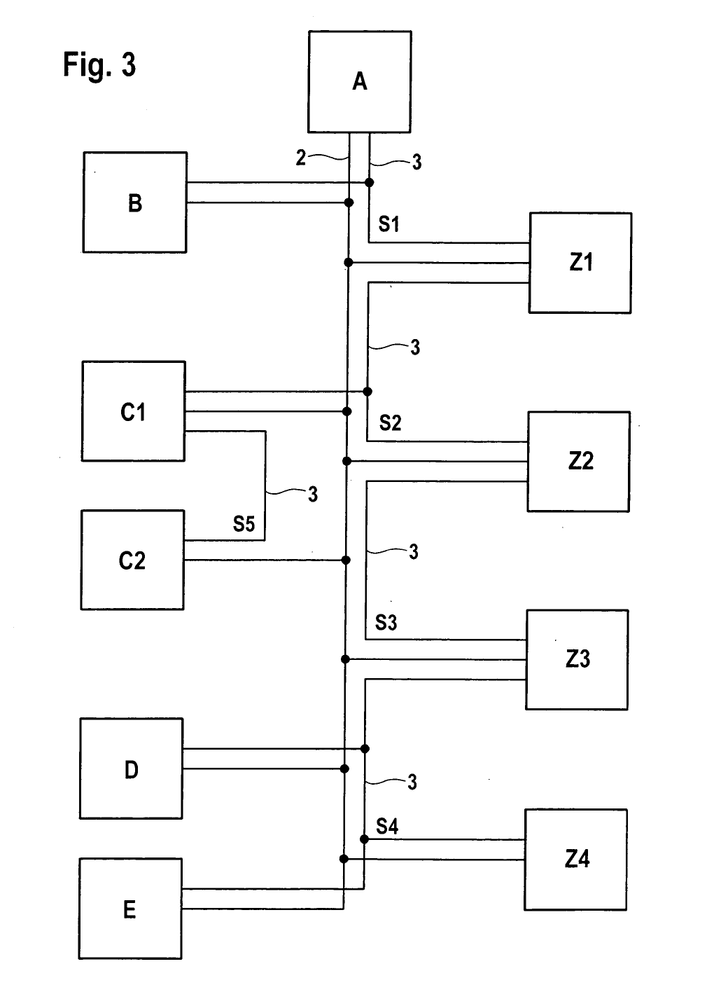

In contrast to this, the exemplary embodiment of FIG. 3 includes additional subscribers, besides master subscriber A and slave subscribers Z1, Z2, Z3, Z4, who are all addressable via the same first address. The broadened bus structure of FIG. 3 has two additional slave subscribers C1 and C2, which are both addressable via the same second address, the first address differing from the second address. Furthermore, the bus structure shown in FIG. 3 includes a slave subscriber B, which is able to be addressed directly by master subscriber A via a third address, the third address differing from the first and the second address. Finally, the bus structure shown in FIG. 3 includes two additional slave subscribers D and E, which are only able to be addressed via slave subscribers Z1, Z2 and Z3 or Z1, Z2, Z3 and Z4 via a fourth address or a fifth address, the fourth and the fifth addresses differing both from each other and from the first address, the second address and the third address. Line 2 for transmitting the clock signal is routed to each individual one of the slave subscribers separately. Line 3 for transmitting the address signals is subdivided, besides the four segments S1-S4, into a fifth segment S5 between subscribers C1 and C2.

The bus structures provided by the exemplary embodiment and/or exemplary method of the present invention according to FIGS. 1-3 and the implementation of the method, according to the exemplary embodiment and/or exemplary method of the present invention, for operating a plurality of subscribers that are addressed via the same addresses in such a bus structure, together with the subsequently described variants for the bus interface of the connected subscribers make possible, especially for serial buses, the collision-free operation of a plurality of subscribers which use the same address, at least upon the initialization. For this, signal line 3, which transmits the address (as a rule, the addresses and the data are transmitted over the same line 3, as, for instance, also on the I²C bus) is subdivided into a plurality of subbranches S1-S5, the subscribers in question X1-X4, Y1-Y4 and Z1-Z4 also functioning as nodes between subbranches S1-S5.

Other signals, such as the clock signal, may furthermore be routed directly to all subscribers (cf. FIG. 2). Consequently, the similar subscribers are not all connected in parallel to main bus 1, but are cascaded: Only a first subscriber X1, Y1, Z1 and C1 is connected directly to original bus S1, and it forms the so-called transition node to subsequent bus segment S2 or S5, by relaying a part of, or all instructions and commands, which it receives from bus S1, to an additional connection by which the transition node is connected to an additional, which may be identical subscriber X2, Y2, Z2 or C2. In this context, depending on the selected variant, the instructions or commands are able to be subjected to specific changes in transition node X1, Y1, Z1 or C1, for instance, to an address conversion. Second subscriber X2, Y2, Z2 or C2 relays the received instructions or commands, if necessary modified again or selected, to a third subscriber X3, Y3 or Z3, and so forth.

The advantage of this bus structure and the method connected with it, for operating similar subscribers in the bus system, is that a plurality of (what may be) identical subscribers are able to be operated on bus 1. Establishing the addresses of the subscribers (for instance, by wire bridges or jumpers) is not necessary before putting bus 1 into operation. Only an additional pin on the modules of the subscribers has to be provided as connection to the subsequent subscriber.

FIG. 5 shows a conventional bus structure, for instance, an I²C bus, in which all subscribers B, C, D, E hang in parallel on all signals of bus 1.

FIG. 1 shows a circuit having several bus segments S1-S4, and all signal lines 3 are subdivided into these segments. Bus subscribers X1, X2 and X3 include a transition node for the selective relaying of bus commands. FIG. 2 shows a variant, in which only signal line 3, via which the address data are also transmitted, and which is subdivided into segments S1-S4. In this way) the address collision between the bus subscribers is still able to be effectively prevented. The clock signal that is transmitted via line 2, on the other hand, does not have to be subdivided, and is therefore able to be routed directly to all subscribers Y1-Y4. In other bus systems, other signals that do not carry address data, such as separate data signals, could also be applied directly to all subscribers.

FIG. 3 shows a complex implementation of a bus system according to the exemplary embodiment and/or exemplary method of the present invention, in which the identical, or rather same address modules Z1-Z4 are clearly identifiable and addressable because of the bus segmentation in bus 1. At segments S1-S4 created thereby, additional subscribers of other types, and therewith also other addresses, are connected. The two subscribers C1 and C2 that are identical to each other are wired, on their part, by a subsegment S5 in such a way that they too are specifically addressable in bus 1 according to the exemplary embodiment and/or exemplary method of the present invention, although they are originally addressable via the same address.

According to a first variant A of the exemplary embodiment and/or exemplary method of the present invention, a permanent address manipulation or address conversion is carried out in real time. In the modules of respective subscribers X1-X3, Y1-Y3, Z1-Z3 and C1 a circuit is provided which, to be sure, relays the data communication to the additionally provided connecting pin, but which first manipulates the address signals according to certain rules. In master subscriber A, different addresses are provided, within a bus structure shown, for each of subscribers X1-X4, Y1-Y4, Z1-Z4, B, C1, C2, D and E that are connected to bus 1. Master subscriber A is able uniquely to address each desired subscriber, via these unique addresses. These addresses, however, do not agree with the original addresses of subscribers X1-X4, Y1-Y4, Z1-Z4 and C1 and C2, since these subscribers are originally addressed via the same address, as was mentioned. According to the first variant, however, only first subscriber X1, Y1, Z1 and C1, the so-called transition node, is still addressed via this original address. Since the addresses of the postconnected subscribers X2-X4, Y2-Y4, Z2-Z4 and C2 are conducted via transition nodes X1, Y1, Z1 and C1, such addresses are able to be recognized by the transition node and appropriately manipulated, so that it corresponds to the original address of one of the postconnected subscribers X2-X4, Y2-Y4, Z2-Z4 and C2. The address conversion takes place during the normal operation of the bus system, for the purpose of transmitting data and information according to specified address conversion rules.

A possible rule for manipulating the address could look as follows: Transition nodes X1, Y1, Z1 and C1 receives an address coming in over bus S1 or line 3 bit by bit (bit-synchronously). Also bit-synchronously, transition node conducts bit for bit via the additional connecting pin to subsequent subscribers X2-X4, Y2-Y4, Z2-Z4 and C2. The transition node checks the incoming address bits, as to whether they agree with the corresponding bits of its own address. The transition node transmits the address bits to the subsequent subscribers only until, for the first time, an incoming address bit does not correspond to the coding of its own address, that is, that it is recognizable for the first time that it is not transition nodes X1, Y1, Z1 and C1 that are to be addressed, but rather, another one, for instance, one of the postconnected subscribers. This bit is then manipulated appropriately by the transition nodes, which may be inverted, before it is relayed to the postconnected subscribers. The manipulation of the address bits has as its aim that one of the postconnected subscribers feels that he is being addressed. All subsequent address bits are relayed by the transition node, either without a further manipulation to subsequent branch S2 or S5 of bus 1, or they are also first manipulated according to the address conversion rules.

If, however, all the address bits incoming at the transition node agree with the address of the transition node, that is, first subscriber X1, Y1, Z1 or C1 is addressed, and consequently the relayed address bits are not destined for the postconnected subscribers at all, first subscriber X1, Y1, Z1 or C1 terminates the communication on the postconnected bus segment, in suitable fashion. For this, the transition node sends as termination, for instance, a certain instruction, a so-called dummy command, by which it is communicated to the postconnected subscribers that they do not have to carry out any action (a so-called “NOP” instruction). Such an instruction, for example, corresponds to an I²C stop condition in the case of an I²C bus.

If a subscriber of the bus system is not addressed by the transmitted address, he relays all additional communications signals, such sub-addresses, data, control commands and the like, which are transmitted over this line, in an unchanged bidirectional manner to the respectively postconnected bus segment S2-S4 and S5, or, in the case of read instructions, data coming from the postconnected bus system to the superordinated bus system S1 to S3.

The advantage of this variant A is that in the modules of the subscribers, no additional storage cells have to be implemented. The data communications on lower priority bus segments S2-S4 and S5 take place synchronously with the main bus S1. Apart from the gate propagation delays, no additional waiting times or delays are created by which the speed of communications would be significantly reduced. This variant is limited to the number of address bits stemming from the number of addressable subscribers originally having the same address. If, for instance, an address is composed of 7 bits, using this variant, only seven subscribers are able to be addressed which originally had the same address. However, in most application cases this is sufficient.

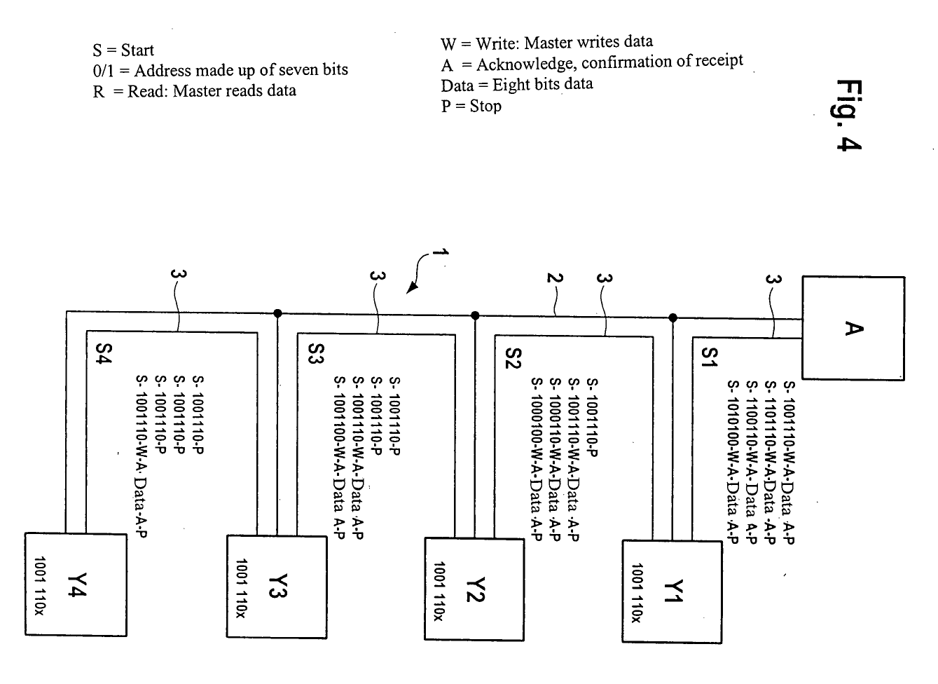

If one imagines a simplified bus structure having only two subscribers connected to it that originally had the same address (cf. the partial bus structure in FIG. 3 including master subscriber A and the two slave subscribers C1 and C2), one could imagine that the two subscribers C1 and C2 were originally addressed via the address “0”. For operation of the bus according to the variant described, the address “1” is, however, assigned to second subscriber C2 for the purpose of addressing it, but in actual fact he still has the address “0”. If master subscriber A wants to address first subscriber C1, he places the address “0” on the bus. Subscriber “C1”, which receives the address first, realizes that he is meant by it. If master subscriber A wants to address second subscriber C2, he places the address “1” on bus 1. First subscriber C1 receives the address and realizes that he is not meant by it. However, so that second subscriber C2 may realize that he is meant by the address “1”, the received address bit “1” first of all has to be converted in transition node C1 to a “0” before being relayed via bus segment S5 to second subscriber C2. Second subscriber C2 then receives the converted or modified address “0” and realizes that he is being addressed. In FIG. 4 a bus communication according to variant A is presented in an exemplary fashion. Master subscriber A (for instance, a control processor) accesses bus 1 and, as master, sends an instruction sequence made up of four written commands, each of these instructions being supposed to reach a different subscriber Y1-Y4 on bus 1. The four subscribers Y1-Y4 are identical and all react to the address 1001110x, “x” representing the direction of transmission, read or write.

Via first segment S1, the instruction sequence reaches first subscriber Y1, which first of all relays it, also synchronously, that is, bit by bit, to second segment S2. In addition, it codes the address of this first instruction and realizes, in the process, that he himself is being addressed. On the one hand, this results in the transmission of the first instruction to second segment S2 being broken off using a “STOP” condition, and on the other hand, in subscriber Y1 executing this first command.

In response to the second instruction, subscriber Y1 does not feel he is being addressed, since the second address bit does not correspond to the respective bit of its address. In response to the relaying to the second segment, just this bit (and only this bit) is inverted, and the rest of the command reaches segment S2 in the original state. The transition of the second address bit effects the conversion of the address in such a way that now second subscriber Y2 is addressed, and “picks out” this second instruction, that is, he does not relay it to third segment S3, but executes it himself.

The third instruction is changed both in first subscriber Y1 by one bit (here bit 2) and in second subscriber Y2 (here bit 4). After these manipulations, the instruction reaches third subscriber Y3 via third segment S3, and he, on his part, realizes that he is being addressed by this instruction, and executes the instruction on his part.

The fourth instruction is changed by one bit (here bit 2) in first subscriber Y1, in second subscriber Y2 (here bit 4) and in third subscriber (here bit 3). After these manipulations, the instruction reaches fourth subscriber Y4 via fourth segment S4, and he feels he is being addressed by the address and executes the instruction.

In a different variant B, an address received in the transition node is first of all buffer-stored, possibly manipulated and then relayed to the postconnected subscribers. The address transmission into the subsequent bus segment thus does not take place in a bit-synchronous method, but only begins after the address transmitted from the superordinated segment S1 to S3 has been completely received and evaluated in the node. The address bit received in the transition node are first of all buffer-stored in a buffer provided for this, and decoded. If the transition node determines that the received address is its own address, the command or the instruction is executed. If the transition node determines, however, that the received address is not its own address, the received address is first converted according to the specified rules, before the command is relayed to the subsequent bus segment. The rule or strategy for address conversion includes, for example, an incrementing and/or decrementing of certain address bits. Under certain circumstances it is meaningful that the transition node excludes all instructions which are directed to its own address from being relayed, since, in any case, no additional subscriber is permitted to react to this command. In order that, during the address transmission in the subsequent bus segment, no transmissions in the superordinated segment are lost, the buffer in the bus node should advantageously be designed as a shift register, through which all the bits coming from the master are routed. The register length may be equivalent to the address length.

The advantage of this variant B lies particularly in the efficient utilization of the bus addresses present. In response to an n-bit address not only n subscribers, as in the first described variant, but up to 2ⁿ subscribers are able to be uniquely addressed. The number of similar subscribers in the bus system is also not restricted by the bit length of the address, but comes about from the number of the free addresses or the efficiency of the address conversion. To be sure, in this variant there comes about a time delay, particularly in the case of a cascading of a plurality of subscribers (cf. for example subscribers X1-X4, Y1-Y4 and Z1-Z4), and with that a slight impairment of the communication speed or a slightly lower data throughput of bus 1. However, this can in most cases be accepted or compensated for, to a great extent, by increasing the clock rate.

One further example starts from a bus 1 according to variant B, having the following stipulations: All subscribers Y1-Y4 use the address 4. All the other addresses are relayed reduced by 2.

Access to subscribers Y1-Y4 takes place according to the method described below: If master subscriber A addresses address 4, he reaches first subscriber Y1 in the chain. Depending on the implementation of the protocol, in this case the next bus segment could remain inactive. If master subscriber A addresses address 8, he reaches third subscriber Y3 in the chain, because first subscriber Y1 makes a new address 6 out of address 8, relays the instruction to second subscriber Y2, which makes an address 4 from address 6, and relays this on his part. Third subscriber Y3 feels he is being addressed using address 4, and executes the corresponding instruction.

According to still another variant C, a transition node relays all commands, which are not directed to its own address, unchanged between the two connected bus segments bidirectionally. This is able to take place using an address coding in real time, in that the transition node first carries out the transmission during the transmission of the address, and only in the case that one's own address is recognized at the end of the address transmission, the transmission into the subsequent bus segment is then broken off using a “NOP” instruction or rather a “STOP” command, so that this command is only decoded and executed in the transition node itself. The blocking of the transition node is lifted using the regular end of the command (STOP command), and the subsequent instructions are again transmitted to all the bus branches, until the next address recognition and a switching off of the segment initiated thereby.

In this initialization state, only the first subscriber X1, Y1, Z1 and C1 of this chain of bus subscribers having the same address is addressable. Therefore, the first subscriber is reprogrammed by master subscriber A (for instance, a control processor) to another, not yet assigned bus address. As of this point in time, one may now access the second postconnected subscriber X2, Y2, Z2 and C2 of the chain via the original address. If necessary, this subscriber too will be reprogrammed to an additional address, so as to reach the third subscriber X3, Y3, Z3, and so forth.

In this variant C, in the modules of the subscribers no additional memory will be implemented for a new address, with the exception of the storage cells. In addition, the data communication on lower priority bus segments S2-S4 and S5 takes place synchronously with main bus 1. Apart from gate propagation delays, no additional waiting times are created by which the communication speed would be lowered significantly. After a one-time reprogramming of the subscriber addresses during an initialization phase, in a steady operating condition, that is, in the regular use, as agreed, of the bus for information and data transmission, no increased effort (expenditure) compared to usual buses is required. Besides, there exists full address flexibility, even mixed with subscribers of other types (cf. FIG. 3).

According to one additional variant D, the transition nodes are activated by a software instruction in a purposeful way, so as to open, that is, to relay incoming instructions to the subsequent bus segments or to switch them over. The transition node in first subscriber X1, Y1, Z1 and C1 is opened by a targeted instruction, so that the further data flow can then advance into subsequent second segment S2 and S5. Thus, an instruction is implemented which has the effect of switching through a connection to subsequent bus segment S2 and S5. The subsequent data of the communication packet find no application in the transition node, but are relayed. They again include, first of all, an address, as a rule, the same address of first subscriber X1, Y1, Z1 and C1, because a postconnected subscriber X2-X4, Y2-Y4, Z2-Z4 and C2 of the same time is to be addressed. If there, too, in the postconnected subscriber, there is again included an instruction for switching through into next bus segment S3, the communication then reaches third subscriber X3, Y3, Z3 in the chain, and so forth. At the end of the communications sequence, for instance, the STOP condition, all connections previously switched open are separated again.

This function of the software controlled switching through of the bus nodes is able to be limited to the initialization phase of bus 1. The end of the chain of equal subscribers is ascertained with the aid of the instructions to switch in segments S2, S3, S4 and S5, and thereafter the addresses of the subscribers are reprogrammed, so that no further collision is present. From that time on, all nodes having an additional switching instruction are switched to permanent data connection and an unhindered data traffic may be carried out according to the known bus specification. Now all nodes have an individual address and all nodes are permanently switched through. The master no longer sees any difference from a regular bus operation, such as a regular I²C bus operation, according to the related art.

The advantages of this variant D are that after a one-time reprogramming of the subscriber addresses in a steady operating condition, no increased effort is required compared to usual buses. Besides, there exists full address flexibility, even mixed with subscribers of other types (cf. FIG. 3). If an implementation is selected in which there is no address reprogramming, the present addresses may be used durably by several subscribers, whereby the number of maximum possible bus subscribers increases correspondingly. However, as was described before, the instruction sequences become longer, since they include the switchover instructions.

According to still another variant E, an automatic collision detection and collision removal is provided within the bus system. In this context, at the start of the bus operation, a procedure is carried out in which colliding bus addresses are automatically detected and assigned afresh. Consequently, as time goes on, no further address collisions are to be observed.

One possible coordination procedure, which is carried out, if necessary, initiated by master subscriber A at the start of the bus operation, may be that each subscriber tries to address an additional subscriber having the same address, which he himself also uses, on its branch of lower priority S1-S5 of bus 1 The first subscriber up until the (n−1)th subscriber of the chain receives a reply to his inquiry, since there is always at least one additional subscriber having the same address hanging on the lower priority branch. Only the last subscriber in the chain has no successor, so that his inquiry remains unanswered. This last subscriber is by definition entitled alone to reclaim the bus address for himself that was used in common up to this point, and subsequently to react to this address on command.

If this last subscriber has received an inquiry from the subscriber preconnected to him, but no reply from a potential postconnected subscriber has been received, the last subscriber in the chain, X4, Y4, Z4 and C2 announces the appearance of the address collision, using a special instruction, and thereby he sort of applies for a new address for the other preconnected similar subscribers in the chain. The master subscriber A generates a new address and sends the instruction on the address conversion to the old, original address. All subscribers that have received a response to their first inquiry, that is, they are not the last subscriber in the chain, and therefore may not keep the address, now convert their own address to the new address. Only the last subscriber in the chain remains with his original address.

If more than two similar subscribers are connected in series on bus 1 (for instance, subscriber X1-X4, Y1-Y4 and Z1-Z4), there are now still at least two subscribers that are able to be reached at the same address. Thus, the address arrangement begins over again: Those subscribers that are still able to be reached at the same address, namely subscribers X1-X3, Y1-Y3 and Z1-Z3 send an inquiry to possibly postconnected subscribers who also utilize this (newly apportioned) address. The next to last subscriber X3, Y3, Z3 in the chain is now the last subscriber having this newly apportioned address, and is therefore permitted to keep its address. He requests a new address for all subscribers X1, X2, Y1, Y2, Z1, Z2 which are connected before him in the chain, and which are also able to be reached under his own address.

These coordination communications are performed until his own new address has also in conclusion been apportioned to first subscriber X1, Y1, Z1, so that then each subscriber is able to be addressed via an individual address. During the coordination communication, first subscriber X1, Y1, Z1 has received altogether three newly apportioned addresses, he being only allowed to keep the address apportioned to him last.

One other strategy for redistributing unit addresses is able to do without the coordination of a central control process in the form of master subscriber A, since the required data concerning the further switching of the addresses are stored in the respective subscribers X1-X3, Y1-Y3, Z1-Z3 and C2: The subscriber who identifies himself first as end of chain is subsequently the only subscriber able to be addressed under this address. If necessary, he sends an appropriate instruction to his own address, and thereby proclaims himself to be the owner of this address. Thereby the handing out process for this address is terminated. All other subscribers, first having the same address, now switch internally to a second address, for instance, triggered by the instruction of the last subscriber in the chain. For this purpose, a list of specified linkage addresses (chaining addresses) may be stored internally in the subscribers. In the simplest case, the original address is simply increased by “1”. After that, the process of coordination for this second address begins anew, next to last subscribers X3, Y3, Z3 now proclaiming themselves, as described above, as end of chain, and thereby as the lone owner of this second address. The process repeats until a subscriber determines that he has no successor, but also no predecessor, having the same address. With that, it is ensured that all at first equally addressed bus subscribers now each have their own individual address. The subscriber that is the last to convert his address, and now no longer determines any collision, proclaims, using a special instruction, the termination of the coordination communication, so that now the actual bus operation may be undertaken for the purpose of data and/or information transmission. Of course, within the scope of the exemplary embodiment and/or exemplary method of the present invention, further alternatives are possible for the start, the synchronization and the ending of the address redistribution.

In the case of this variant E it should be made certain that the newly apportioned addresses have not already been occupied by other subscriber types in bus 1. This could be ensured in the manner described below. The subscriber that forms the end of the chain of similar subscribers having the same address, and who proclaims himself to be the sole owner of an address, is also responsible for the selection of a suitable alternative address. For this, he generates a new address (for instance, by simple incrementing of the original address) and sends an inquiry into both adjacent bus branches as to whether this address is already being utilized by another subscriber. If this is the case, a new address is generated and checked again. If the address is free, this end node sends an appropriate reprogramming instruction to his own address, and in this manner causes all subscribers, that are still set to this address, now to use this new address and, if necessary, to arrange among themselves who is now finally entitled to utilize this new address.

All bus subscribers that later wish to address these subscribers (especially master subscriber A) observe this coordination communication on bus 1 and memorize which addresses were detected as admissible alternative addresses, and by which subscribers they were taken into possession and subsequently have to be addressed in order to reach the various subscribers of the same type.

The advantage of this method is that after a one-time collision detection and resorting of the subscriber addresses in the use of the bus, as agreed, for the purpose of data and/or information transmission in steady operating condition, no increased effort is required compared to usual bus systems. This variant is also able to run without the coordination by a master subscriber A, the similar subscribers then reaching agreement among themselves.

What is claimed is:

1. A method for operating a plurality of subscribers (X1, X4; Y1, . . . , Y4; Z1, . . . , Z4, B, C1, C2, D, E) connected to a serial bus, the bus including at least one address line for addressing the subscribers (X1, . . . , X4; Y1, . . . , Y4; Z1, . . . , Z4, B, C1, C2, D, E), the method comprising:
connecting, at least those subscribers (X1, . . . , X4; Y1, . . . , Y4; Z1, . . . , Z4, C1, C2), who were originally addressed via the same address, in series to the address line, and
transmitting the address for the postconnected subscribers (X2, . . . , X4; Y2, . . . , Y4; Z2, . . . , Z4; C2) via the preconnected subscribers (X1; Y1, Z1; C1).

2. The method of claim 1, wherein, during actual operation of the bus for information transmission, an address conversion takes place of the originally same addresses of the subscribers (X1, . . . , X4; Y1, . . . , Y4; Z1, . . . , Z4, C1, C2), that are connected in series, to different addresses.

3. The method of claim 2, wherein in all but the last subscribers (X1, . . . , X3; Y1, Y3; Z1, . . . , Z3; C1), that are connected in series, the address conversion is carried out in each case for the postconnected subscribers (X2, . . . , X4; Y2, . . . , Y4; Z2, . . . , Z4, C2).

4. The method of claim 3, wherein:
in all but the last subscribers (X1, . . . , X3; Y1, . . . , Y3; Z1, . . . , Z3; C1), that are connected in series, rules for the address conversion of the postconnected subscriber(s) (X2, . . . , X4; Y2, . . . , Y4; Z2, . . . , Z4, C2) are stored, and
all but the last of the subscribers (X1, . . . , X3; Y1, . . . , Y3; Z1, . . . , Z3; C1) check an incoming address as to whether it is their own address, and if it is not their own address, they manipulate the incoming address according to appropriate address conversion rules and they relay it to the postconnected subscribers (X2, . . . , X4; Y2, . . . , Y4; Z2, . . . , Z4; C2).

5. The method of claim 4, wherein the subscribers (X1, . . . , X3; Y1, . . . , Y3; Z1, . . . , Z3; C1) check the incoming address bit by bit, manipulate it if necessary and relay it to the postconnected subscribers (X2, . . . , X4; Y2, . . . , Y4; Z2, . . . , Z4; C2).

6. The method of claim 5, wherein the subscribers (X1, . . . , X3; Y1, . . . , Y3; Z1, . . . , Z3; C1) relay a first incoming address bit that does not agree with a bit combination of the address of the subscriber (X1, . . . , X3; Y1, . . . , Y3; Z1, . . . , Z3; C1) to the postconnected subscribers (X2, . . . , X4; Y2, . . . , Y4; Z2, . . . , Z4; C2) as previously transmitted address bits or as all other address bits, using another transmission regulation or manipulation regulation.

7. The method of claim 4, wherein the incoming address is buffer-stored and decoded in the subscribers (X1, . . . , X3; Y1, . . . , Y3; Z1, . . . , Z3; C1), and, if necessary, at least one address bit is purposefully manipulated, and the manipulated address is relayed to the postconnected subscriber(s) (X2, . . . , X4; Y2, . . . , Y4; Z2, . . . , Z4; C2).

8. The method of claim 4, wherein the subscribers (X1, . . . , X3; Y1, . . . , Y3; Z1, . . . , Z3; C1) at least one of prevent the relaying of the communication to the postconnected subscribers (X2, . . . , X4; Y2, . . . , Y4; Z2, . . . , Z4; C2), break it off ahead of time and modify it, if it is directed at their own address.

9. The method of claim 8, wherein the subscribers (X1, . . . , X3; Y1, . . . 0, Y3; Z1, . . . , Z3; C1) are set by switchover instructions to at least one of relay a single communications sequence and permanently relay all communications sequences up until one of an arrival of an event, a switch-off command and a reinitialization of the subscriber (X1, . . . , X3; Y1, . . . , Y3; Z1, . . . , Z3; C1).

10. The method of claim 1, wherein, during an initialization phase before actual operation of the bus for information transmission, a reprogramming takes place of the originally same addresses of the subscribers (X1, . . . . , X4; Y1, . . . , Y4; Z1, . . . , Z4; C1, C2), that are connected in series, to different addresses.

11. The method of claim 10, wherein a master subscriber that is connected to the bus arranges for and coordinates the reprogramming of the addresses.

12. The method of claim 10, wherein a master subscriber that is connected to the bus arranges for the reprogramming of the addresses, and at least a few of the subscribers (X1, . . . , X4; Y1, . . . , Y4; Z1, . . . , Z4; C1, C2) coordinate the reprogramming of the addresses.

13. The method of claim 10, wherein at least two of the subscribers (X1, . . . , X4; Y1, . . . , Y4; Z1, . . . , Z4; C1, C2) arrange for and coordinate the reprogramming of the addresses.

14. The method of claim 12, wherein in at least two of the subscribers (X1, . . . , X4; Y1, Y4; Z1, . . . , Z4; C1, C2), that are connected in series, one of alternative addresses and regulations for forming the alternative addresses are stored, to which the subscriber (X2, . . . , X4; Y2, . . . , Y4; Z2, . . . , Z4; C2) is switched over for reprogramming the address.

15. The method of claim 10, wherein the method is performed until all subscribers (X1, . . . , X4; Y1, . . . , Y4; Z1, . . . , Z4; C1, C2) are able to be addressed during operation of the bus for the information transmission via different addresses.

16. A subscriber of a plurality of subscribers (X1, . . . , X4; Y1, . . . , Y4; Z1, . . . , Z4; C1, C2) connected to a serial bus, at least two of the subscribers (X1, . . . , X4; Y1, . . . , Y4; Z1, . . . , Z4; C1, C2) being addressable via the same address, and the bus including at least one address line (3) for addressing the subscribers (X1, . . . , X4; Y1, . . . , Y4; Z1, . . . , Z4; C1, C2), the subscriber (X1, . . . , X3; Y1, . . . , Y3; Z1, . . . , Z3; C1) comprising:
a first arrangement for connection to the address line;
a second arrangement for connection of one of those subscribers (X2, . . . , X4; Y2, . . . , Y4; Z2, . . . , Z4; C2) who are originally addressable via the same address as he himself, so that the subscribers (X1, . . . , X4; Y1, . . . , Y4; Z1, . . . , Z4; C1; C2) are connected in series to the address line (3) via the subscriber (X1, . . . , X3; Y1, . . . , Y3; Z1, . . . , Z3; C1); and
a third arrangement for transmitting the address for the postconnected subscriber(s) (X2, . . . , X4; Y2, . . . , Y4; Z2, . . . , Z4; C2).

17. The subscriber of claim 16, wherein:
the subscriber (X1, . . . , X3; Y1, . . . , Y3; Z1, . . . , Z3; C1) includes an arrangement for operating a plurality of subscribers (X1, X4; Y1, . . . , Y4; Z1, . . . , Z4, B, C1, C2, D, E) connected to a serial bus, the bus including at least one address line for addressing the subscribers (X1, . . . , X4; Y1, . . . , Y4; Z1, . . . , Z4, B, C1, C2, D, E),
at least those subscribers (X1, . . . , X4; Y1, . . . , Y4; Z1, . . . , Z4, C1, C2), who were originally addressed via the same address, are connected in series to the address line, and the address for the postconnected subscribers (X2, . . . , X4; Y2, . . . , Y4; Z2, . . . , Z4; C2) is transmitted via the preconnected subscribers (X1; Y1, Z1; C1), and
during actual operation of the bus for information transmission, an address conversion takes place of the originally same addresses of the subscribers (X1, . . . , X4; Y1, . . . , Y4; Z1, . . . , Z4, C1, C2), that are connected in series, to different addresses.
